(19) United States
(12) Patent Application Publication
(10) Pub. No.: US 2009/0198470 A1
(43) Pub. Date: Aug. 6, 2009

(54) Method for optimizing an accelerated scaled stress test

(75) Inventors: Pascal Lantieri, Ecouflant (FR); Fabrice Guerin, Angers (FR)

Correspondence Address: YOUNG & THOMPSON, 209 Madison Street, Suite 500, ALEXANDRIA, VA, 22314, US

(73) Assignee: ENSAM, Paris (FR)

(21) Appl. No.: 11/664,798

(22) PCT Filed: Oct. 7, 2005
(86) PCT No.: PCT/FR05/02501

§ 371 Date: Mar. 19, 2009

(30) Foreign Application Priority Data
Oct. 8, 2004 (FR) 0410650

(51) Int. Cl. G06F 19/00

(52) U.S. Cl. 702/113

(57) ABSTRACT

The invention concerns a method for defining scaled stresses indicating an estimation of the product reliability with maximum accuracy. It comprises a phase which consists in inputting characteristic parameters (1), defining a sequence of stresses and simulating occurrences of failure time (2), estimating the characteristic parameters with indication of trust intervals (3), estimating proportions of faulty parts (4), a phase of testing the accuracy of the estimation (5), a feedback on phase (2) defining the cycle of stresses in case of insufficient accuracy. That set of operations (6) is only simulated, but when the estimation of proportion is determined to be sufficiently accurate, the cycle of stresses is implemented on a real test. The inventive method can also be used to test electronic products sensitive to thermal or vibratory stresses as well as mechanical products sensitive to fatigue stresses.

This invention relates to a process that allows prompt and precise estimation of the reliability of an electronic or mechanical product. This process consists in defining a sequence of scaled, more rigorous stresses to which the product will be exposed to estimate its reliability. In fact, for a given sample size and test time, the precision of an estimation of reliability that has been deduced from the failure times obtained during a scaled stress test is a function of the distribution of said failure times on various stress scales. The operator assigned to test the reliability of the product thus has an interest in making a selection of the levels of stress allowing minimization of the test time necessary for estimating said reliability with the required precision.

This reliability will be measured by estimating the proportion of units of this product that have been put into service and that will undergo failure before a given operating time at a given stress level.

Empirical observations have shown that for a fixed sample size and test time and for scales with equal durations, the estimation of this proportion is especially precise when the distribution of failures during a test satisfies the following four criteria as closely as possible.

It is first necessary that the average of the stress levels at failure be as near as possible to the average of the assigned stress levels. It is likewise necessary that the test sample experience as many failures as possible and that there is roughly one failure at the increments of extreme stresses. Finally, it is necessary that the increase of the stress level between each increment be as near as possible to the standard deviation of the stress levels at failure.

To define a sequence of stresses that allows these criteria to be satisfied as well as possible and to check if the level of precision on the estimation of the proportion will be sufficient, it is useful to initiate, before undertaking the actual test, simulations of tests or theoretical evaluations of the average number of failures on each increment. This can be done based on assumed values of the characteristic parameters of the distribution of the service lives under nominal strain, on the one hand, and the law of acceleration of appearances of failures with the stress level, on the other hand.

The operator begins by arbitrarily defining a sequence of stresses. Using any software or a spreadsheet, he then generates random values that are distributed according to the assumed values of said characteristic parameters. These values represent the failure times that would have been obtained during an actual test on a product with these characteristics.

He then carries out a statistical treatment that makes it possible to obtain a point estimation of the proportion of failures that is to be predicted. He likewise determines, at a given confidence level, a confidence interval for this proportion (unilaterally to the left).

If this confidence interval is narrow enough to allow correct qualification of the tested product, the stress sequence that has been defined by the operator will be accepted as is. The test will then be done by reproducing this sequence. In the opposite case, the stress sequence will be modified in order to better meet the four criteria enumerated above. To re-adjust the stress sequence, the operator will have to modify it until the average theoretical numbers of failures for each increment will better satisfy said criteria. A new simulation will then be implemented. This process will be reproduced until the confidence interval of said failure proportion that has been deduced from the test simulation is narrow enough.

In the case of electronic products that are stressed solely in temperature, with a failure rate that is constant over time at a given temperature, and for which the law of acceleration of appearances of failures with temperature is described by an Arrhenius model, the characteristic parameters will be:
The failure rate λ₀ under nominal conditions, i.e., without vibrations and at ambient temperature,
The activation energy Eₐ that makes it possible to define the Arrhenius law that controls the development of the failure rate with the temperature.

The stress levels will be the temperatures formed by a climate chamber.

For electronic products that can be vibrationally stressed, the distribution law of the service lives at the nominal vibration level and the acceleration law of degradation are likewise a function of characteristic parameters. The stress levels are the vibration powers generated by a vibrating plate moved randomly following six degrees of freedom that characterize the displacement of a solid.

For mechanical products stressed in alternating strains, the stress levels will be fatigue strains generated by a push-pull, bending; or alternating torsion machine. The characteristic parameters will then be:
The parameters of a log normal law defining the numbers of rupture cycles of the product for the nominal strain level S₀,
Those of the characteristic de Basquin law of development of the number of rupture cycles with the fatigue strain level if it is a matter of limited fatigue or those of the Coffin Manson law in the case in which the product is exposed to oligocyclic fatigue, these laws defining in both cases the development of the average number of rupture cycles with the increase in the strain level.

Since the process is implemented analogously for electronic products subjected to vibration stress and mechanical products subjected to fatigue stress, it is sufficient to describe it solely for electronic products exposed to temperature stress with the aforementioned characteristics (lines 12 to 19).

For thermal stresses scaled with temperature increments of the same duration, for example, the stress sequence will be entirely determined by the values of the first stress level T₁, of the increment ΔT between two successive temperature increments, of the time of the increment τ, and of the number of stages s.

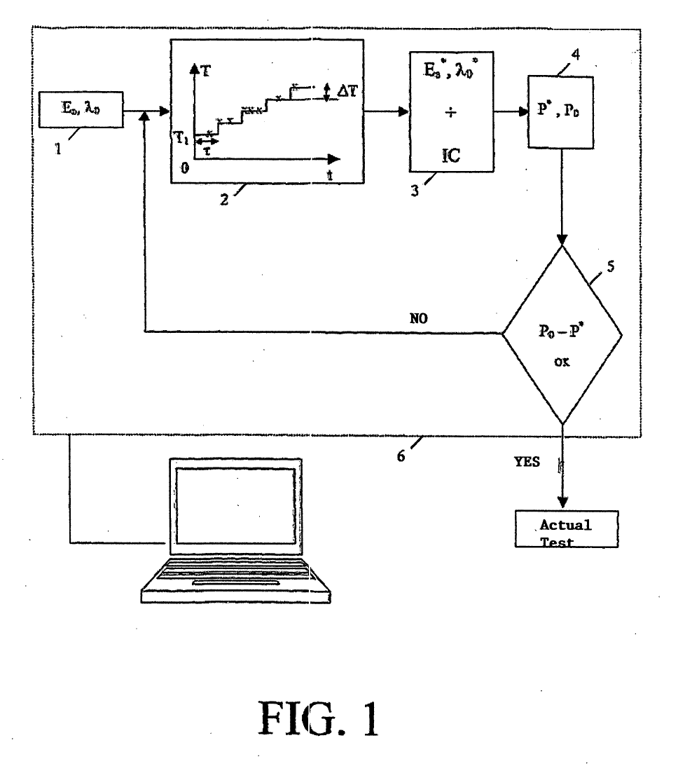

Implementation of the process comprising the invention on this example is illustrated in FIG. 1. Each stage (i) of the process is shown there by a block referenced by this number.

Stage (1): The operator inputs into his software or his spreadsheet the assumed values of the parameters Eₐ and λ₀ (1), defined above.

Stage (2): The operator selects and inputs the values of the parameters T₁, τ and ΔT that define the sequence of simulated thermal stresses. He then calculates the failure time tⱼₖ for each increment k and taking the instant of starting of the increment k for the origin, with the following formula:

tᵢₖ=−Ln(1−x)/λ(Tₖ)

where x is a random number between 0 and 1 (given by the random number generator of the software or spreadsheet) and in which λ(Tₖ) is the failure rate at the absolute temperature Tₖ of the increment k.

This failure rate is given by:

λ(Tₖ)=λ₀θ^{-Ea/kB.(1/Tk-1/T0)}

where k_{B} is the Boltzmann constant, and T₀ is the nominal temperature in K.

For a sample of size N, the operator thus calculates N values of the failure time for the first increment. He retains only the N₁ values that are less than τ. He then calculates N−N₁ values for the second increment and retains only the values that are less than τ. He continues in this way as far as the last increment.

Stage (3): Using this list of values of failure times, the operator then determines the estimations Eₐ* and λ₀* of the parameters Eₐ and λ₀ by maximization of the likelihood function:

L(Eₐ, λ₀)=Ln(λ₀) N₁+Eₐs₁−λ₀s₂

where N_{f} is the total number of failures of all increments together, where s₁ is the sum of Nₖxₖ and where s₂ is the sum of quantities TTₖ.e^{Eaxk} with xₖ=−1/k_{B}(1/Tₖ−1/T₀) and where TTₖ is the total operating time of the units tested at increment k.

To determine the confidence intervals of these parameters at a given confidence level α, the operator then calculates the Fisher matrix defined by the estimations of Eₐ and Ln(λ₀), i.e., the symmetrical matrix composed of all second derivatives of L relative to these 2 parameters.

The operator calculates therefrom the inverse F⁻¹ and retrieves the diagonal elements. The two retrieved elements constitute the variance of the different estimations of Eₐ and λ₀ that would have been obtained for a large number of tests that are identical to the one that was used to obtain estimations of Eₐ and Ln(λ₀). The standard deviations σ(Eₐ) and σ[Ln(λ₀)] are then calculated by extracting the square root of said variances. A point estimation Pₜ* and a maximum P₀ at the fixed level α of the proportion of failures can then be obtained for a given temperature T and a given operating time t by applying the formulas:

P₁*=1−e^{λ0*t.Exp(Ea8λ(T))}

and P₀=1−Exp[−e^{M-1}_{α}^{Σ}]

where λ₀* and Eₐ* are the point estimations of λ₀ and Eₐ obtained by maximizing L,

M=Ln(t)+Ln(λ₀*)+Eₐ*.x_{T} (with x_{T}=−1/k_{B}(1/T−1/T₀)),

Σ=[σ(Ln(λ₀))²+x_{T}²σ(Eₐ)²] and where t_{α} is the quantile at level α of the standard normal law.

Stage (5): A test is run on the confidence interval of said proportion of failures. If the amount P₀-Pₜ* is greater than a threshold that has been fixed by the operator, this indicates that an actual test defined on the basis of a selected sequence of stresses does not allow estimation of the proportion of failures that has been sought with sufficient precision. It is thus necessary to modify the sequence of thermal stresses by returning to stage (2) in order that the distribution of failure temperatures obtained during new simulations is nearer the four criteria enumerated above.

If the modification of the initial stress sequence is sufficient for the value of P₀-Pₜ* to assume a value that is less than the threshold fixed by the operator, the actual test will be able to be carried out and the estimates Eₐ*, λ₀*, Pₜ* as well as the maximum value P₀ will be able to be obtained based on the failure times recorded during the test and with the same formulas as for the simulated failure times.

With each modification of the stress sequence, the operator evaluates, no longer the number of failures obtained during a test simulation, but the average numbers of theoretical failures nₖ and their theoretical standard deviations σₖ for each of the stress increments. In the case of electronic products subjected to the above-described temperature tests, these quantities will be calculated for

k>1 using the following formulas:

nₖ=N.(1−e^{-λ(T}ₖ^{)t}).e^{-SOM}ₖ₋₁^{.t} and σₖ=[N.(1−e^{λ(T}ₖ^{)t}).e^{-SOM}ₖ₋₁^{.t}]^{0.5}

where SOMₖ₋₁ is the sum of the failure rates for the temperatures Tⱼ, j varying from 1 to k−1.

For the first increment, the quantities will be calculated with the formulas:

n₁=N.(1−e^{λ(T}₁^{).T}) and σ₁=[N.e^{-λ(T}₁^{).t})]^{0.5}

The parameters T₁, ΔT and s that define the sequence of thermal stresses will thus be selected such that the four criteria, according to empirical observations, which make it possible to obtain an exact estimate of the reliability, aire best satisfied. This can be done by multiplying more or less arbitrary choices that are systematically tested by simulation, but, to arrive more quickly at the desired result, the operator will use the following strategy:
1) Calculate the list of nₖ, σₖ using the preceding formulas.
2) If n₁+t_{α}σ₁ is clearly greater than 1, reduce the first increment (t_{α} being the quantile of the level α of the standard normal lawm with α=0.95). If n₁+t_{α}σ₁ is less than 1, raise the first increment again.
3) If nₛ+t_{α}σₛ is less than 1, reduce the last increment. If nₛ+t_{α}σ₅ is clearly greater than 1, raise the last increment again.
4) If the sum of nₖ is clearly less than N, raise the set of increments again.
5) Calculate ΔT=(Tₛ−T₁)/(s−1) and position the intermediate increments.
6) If the theoretical average m=ΣnᵢSᵢ/N is remote from (T₁+tₛ)/2, shift the increments in the direction allowing correction of this deviation. If the theoretical standard deviation (Σnᵢ(Tᵢ−m)²/(N−1))^{1/2} is remote from T_{S}, move the increments farther apart or closer together as a result.

The levels of these stresses must in any case remain below the stress level based on which the failures are no longer of the same nature as under nominal conditions.

In the case of vibration tests on electronic products, the parameters of the service life distribution law under nominal conditions aLnd those of said acceleration law will be input at stage (1) in the same way as for the thermal stress tests. The stress sequence defined in stage (2) will be modified by replacing all the information relating to the temperatures by the same information relating to the vibration levels. Point estimations of said characteristic parameters and confidence intervals will be determined as described in stages 3 and 4. The test that indicates the condition of feedback in stage (2) and of performance of the actual test on the vibrating system is identical.

The method for improving, as the case may be, the sequence of stresses is based, as in the case of temperature stresses, on the distribution of the theoretical numbers of failures for each vibration level, and the criteria for which the estimation of reliability will be precise are the same as for the temperature stresses.

In the case of fatigue tests on mechanical products, the number of rupture cycles can be simulated using a spreadsheet in a manner analogous to the simulation of the failure time of electronic products. The characteristic parameters can likewise be estimated by maximizing the likelihood function, but, as the problem comprises more than two parameters, their confidence intervals as well as the maximum rupture proportion for a given number of cycles and a given level of strain will be more suitably determined by reproducing in a loop the point estimations a large number of times.

Whatever the mechanical products subjected to fatigue stress or electronic products subjected to temperature or vibration stress, the process will be applicable as long as the distribution of the service lives at a given level of stress and the acceleration model of the degradation with the increase of the stress level are known.

1. Process for defining a sequence of thermal, vibratory, or push-pull stresses, bending or alternating torsions that make it possible to maximize the precision of an estimation of the service life or an estimation of the proportion of failures for ana interval and a level or set of levels of given stresses, the process being characterized by the following stages:
Stage (1): A succession of stress levels (temperatures, vibration levels, or fatigue strain levels) is defined arbitrarily or following any rule whatsoever,
Stage (2): The distribution of the failures on the various stress levels is examined theoretically or by simulation,
Stage (3): The characteristic parameters of the laws of distribution of service lives at a given stress level or of the acceleration law with the level of stress of the appearance of failures; are estimated at points or by intervals,
Stage (4): A distribution of the service lives of the tested product or said proportion of failures is estimated by indicating its maximum value at a given confidence level,
Stage (5): The precision of the estimation obtained is tested and the sequence of stresses is modified by reproducing these last four stages as long as the precision of the estimation is not considered sufficient, i.e., as long as the standard deviation of the estimations, or, what amounts to the same thing, the difference between the maximum at a given confidence level and a point estimation, remains above a threshold that is defined by the user.

2. Process according to claim 1, allowing optimization of a sequence of stresses of a mechanical product by fatigue or of an electronic product by temperature or vibration in order to obtain—more promptly or with a sample of reduced size—an estimation of the level of reliability of said product with an assigned precision.

3. Process according to claim 1 for which the distributions of service lives at a stress level and the acceleration law of appearances of failures with the increase of the stress level is known or can be known following tests performed on the tested product or on similar products.

4. Process according to claim 1 for which a distribution of the theoretical numbers of failures on various stress levels that were described in stage (2) of this process is established in order to reduce the test time necessary to estimate the reliability of the product with an assigned precision level.

5. Process according to claim 2 for which the distributions of service lives at a stress level and the acceleration law of appearances of failures with the increase of the stress level is known or can be known following tests performed on the tested product or on similar products.

6. Process according to claim 2 for which a distribution of the theoretical numbers of failures on various stress levels that were described in stage (2) of this process is established in order to reduce the test time necessary to estimate the reliability of the product with an assigned precision level.

7. Process according to claim 3 for which a distribution of the theoretical numbers of failures on various stress levels that were described in stage (2) of this process is established in order to reduce the test time necessary to estimate the reliability of the product with an assigned precision level.
